(19) United States
(12) Patent Application Publication
(10) Pub. No.: US 2013/0235209 A1
(43) Pub. Date: Sep. 12, 2013

(54) SYSTEM AND METHOD FOR DISPATCHING VIDEO RECORDING

(71) Applicants: Ho-Hsin Lee, Hsinchu City (TW); Jian-Ren Chen, Hsinchu County (TW); Chieh-Chen Cheng, Taichung City (TW); Yueh-Hsun Hsieh, Changhua County (TW)

(72) Inventors: Ho-Hsin Lee, Hsinchu City (TW); Jian-Ren Chen, Hsinchu County (TW); Chieh-Chen Cheng, Taichung City (TW); Yueh-Hsun Hsieh, Changhua County (TW)

(73) Assignee: Industrial Technology Research Institute, Hsinchu (TW)

(21) Appl. No.: 13/537,056

(22) Filed: Jun. 29, 2012

(30) Foreign Application Priority Data
Mar. 9, 2012 (TW) 101108146

(51) Int. Cl. H04N 7/18

(52) U.S. Cl. 348/159; 348/E07.086

(57) ABSTRACT

A system and a method for dispatching of video recording are provided. In the method, one or more video recording servers having an available CPU utilization larger than an average CPU loading per task is found from one or more video recording servers having a task capability greater than zero. One of the found one or more video recording servers is selected to execute a video recording task whose execution status is indicated as unexecuted in a video recording task status table.

### CROSS-REFERENCE TO RELATED APPLICATION

This application claims the priority benefit of Taiwan application serial no. 101108146, filed Mar. 9, 2012. The entirety of the above-mentioned patent application is hereby incorporated by reference herein and made a part of this specification.

### TECHNICAL FIELD

The present application relates to a system and a method of video recording. Further, the present application relates to a system and a method for dispatching video recording.

### BACKGROUND

The applications of video surveillance are widely used in people's daily life. By mounting cameras at corners in the city and transmitting the recorded images back to the security control center, the security guards can perform the security surveillance or the surveillance apparatus can analyze the recorded images to accomplish the security surveillance. Following the increase of the number of the video cameras, the storage and management of the recorded images become a very difficult job.

Conventionally, the video surveillance system utilizes cameras and video recorders in a way of one-on-one stationary matching so that the video recorder records images captured by the corresponding matched camera. However, when the number of the cameras is increased, it is necessary to establish a complex matching mechanism to manage the cameras and the video recorders. Once one of the video recorders malfunctions, it is necessary to re-establish the matching relationships between the video recorders and the cameras to recover the broken-down video recording service. However, the aforementioned situation bothers the user a lot. Moreover, the requirement of the video recording varies, but the conventional method of video recording is to keep all video recorders working without adopting the method for effectively utilizing resources, which lead to waste of resources.

### SUMMARY

The present disclosure provides a system and a method for dispatching video recording capable of simplifying the management of the video recording service of the multiple cameras and the modulation of resources to achieve the functions of rapidly recovering the malfunction video recording service and effectively utilizing the resources.

According to a method for dispatching video recording in one embodiment of the present disclosure, one or more video recording server with the available CPU utilization larger than the average CPU loading is found from one or more video recording server with the task capability greater than zero and one of the found one or more video recording servers is selected to execute a video recording task with an execution status labelled as an unexecuted status in a video recording task status table.

According to one embodiment of the present disclosure, a system for dispatching video recording comprises a dispatching server having task dispatching module. The task dispatching module determines one or more video recording servers with an available CPU utilization larger than an average CPU loading from one or more video recording servers having a task capability greater than zero, selects one of the determined one or more video recording servers and assigns a video recording task with an execution status labelled as an unexecuted status in a video recording task status table.

Accordingly, the method and the system of dispatching video recording utilize the dispatching server to manage the video recording tasks. During the video recording tasks are dispatched, the CPU loading of the video recording server is taken into account to select the video recording server to execute the video recording task. Thus, the utilization of the hardware resource and the power can be greatly improved to achieve a better utilization efficiency of the system resource.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram showing a structure of a system of dispatching video recording according to one embodiment of the disclosure.

FIG. 2 is a full flow chart showing a method of dispatching video recording according to one embodiment of the disclosure.

FIG. 3 is a block diagram showing a system of dispatching video recording according to one embodiment of the disclosure.

FIG. 4 is a schematic diagram showing a recovery mechanism from malfunction according to one embodiment of the disclosure.

FIG. 5 is a flow chart showing a method of dispatching video recording according to one embodiment of the disclosure.

FIG. 6 is a flow chart showing a method for handling the malfunction video recording server according to one embodiment of the disclosure.

FIG. 7 is a flow chart showing a method for handling the unusual connection of the cameras according to one embodiment of the disclosure.

FIG. 8 is a flow chart showing a method for modulating resources of the video recording servers according to one embodiment of the disclosure.

FIG. 9 is a schematic diagram showing a suspending procedure and a resuming procedure of the video recording server according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides a system and a method for dispatching video recording capable of simplifying the management of the video recording service of the multiple cameras and the modulation of resources to achieve the functions of rapidly recovering the malfunction video recording service and effectively utilizing the resources. The present method can be applied on various video recording services such as massive video recording, scheduled video recording or multiple video recording of the same camera.

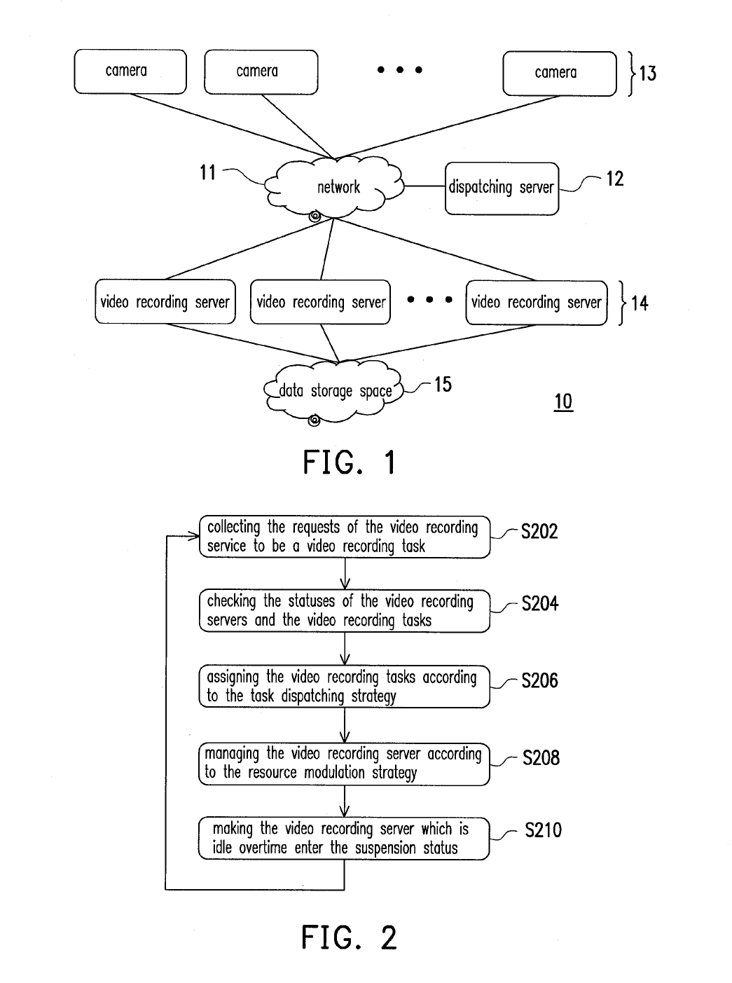

FIG. 1 is a schematic diagram showing a structure of a system of dispatching video recording according to one embodiment of the disclosure. However, the disclosure is not limited thereto. As shown in FIG. 1, a dispatching system 10 for dispatching video recording is connected to a dispatching server 12 and several video recording servers 14 through the network 11, and each of the video recording servers 14 is further connected to a data storage space 15 for providing storage of the recorded data. The storage spaces 15 can be storage devices, such as the memories or hard disks, equipped within the video recording servers 14 and also can be the cloud storage device providing data storage in the network. However, the present disclosure is not limited thereto. The dispatching system 10 can dispatch the connections to one or multiple cameras 13 at the local ends or the remote ends to execute the video recording services.

FIG. 2 is a full flow chart showing a method of dispatching video recording according to one embodiment of the disclosure. However, the disclosure is not limited thereto. The exemplary steps of the method of dispatching video recording are described accompanied with each element of the aforementioned dispatching system 10 in the following paragraphs.

As shown in FIG. 2, the dispatching system 10 has a main procedure which is executed periodically. The main procedure is executed each minute from the very beginning or based on demand of the new video recording service. More specifically, the user can use an external request registration program to input the request of the video recording service and the request registration program collects all requests of the video recording service input by the user. In order to save the storage space of the video-audio images, the video recording task is created based on the time duration or duplicated time durations needed by each of the cameras 13, and then transmitted to the dispatching server 12. The video recording task is recorded in a video recording task table in the dispatching server 12 (step S202). When the time durations of the requests of the video recording services on the same camera 13 are not contiguous, several video recording tasks are established respectively. When the time durations of the requests of the video recording services on the same camera 13 by the users are contiguous or duplicated, the requests of the video recording services on the same camera 13 are combined to be one video recording task. No matter the video recording tasks are executed or not, the corresponding execution statuses of these video recording tasks are reflected on a video recording task status table in the dispatching server 12.

The dispatching server 12 obtains the new collected video recording task table and compares the video recording task table with the stored video recording task status table. When the video recording task should be stopped but actually it is not, an action of stopping the video recording task is executed. The dispatching server 12 checks the statuses of all video recording server 14 (step S204) to set the status of the video recording task which is executed on the video recording server 14 as an unexecuted status while the video recording server 14 has not reported the status of the video recording task executed by itself for a long time. When the video recording task should be executed but actually it is not, the dispatching server 12 select an adequate video recording server 14 or awake a suspended video recording server 14 to perform the recording according to a dispatching mechanism of video recording (step S206). When a video recording task has been executed but the status of it does not exist in the video recording task status table, the dispatching server 12 establishes a video recording task status record corresponding to the executed video recording task and stores the record into the video recording task status table.

Furthermore, the dispatching server 12 selects the video recording servers 14 needed to be modulated according to a resource modulation strategy so as to rapidly make the video recording server 14 with high available CPU utilization lie idle and enter a suspension status with less power consumption. Meanwhile, the video recording task of the suspended video recording server 14 is re-allocated to other video recording servers 14 (step S208) to improve the utilization of the other video recording servers 14.

The modulation step of the dispatching server 12 is to check whether there is a video recording server 14 with the available CPU utilization higher than the threshold value of the task modulation. This threshold value of the task modulation is the product of the total CPU utilization per video recording server and a specific percentage. When it is determined that there is a video recording server 14 with the available CPU utilization higher than the threshold value of the task modulation, one or more of the other still operated video recording servers 14 which has the available CPU utilization enough for executing the video recording task is selected and the selected video recording servers 14 is assigned to execute the transferred video recording task. Regarding the method of selecting one of the other video recording servers, it can be, for example, by random pick, sequentially pick or by picking the last booting video recording server. Alternatively, one of the other video recording servers with the maximum total CPU utilization per video recording server and larger than the original video recording server can be selected, for example. In addition, the dispatching server 12 further requests the original video recording server 14 to stop executing the video recording task to be transferred and makes the original video recording server 14 enter the suspension status.

The dispatching server 12 checks all of the operating video recording servers 14 to find out the video recording server 14 which is idle for a period of time and larger than the threshold value of the idle time period, and makes the discovered video recording server 14 enter the suspension status for power saving (step S210). The threshold value of the idle time period is a specific time period.

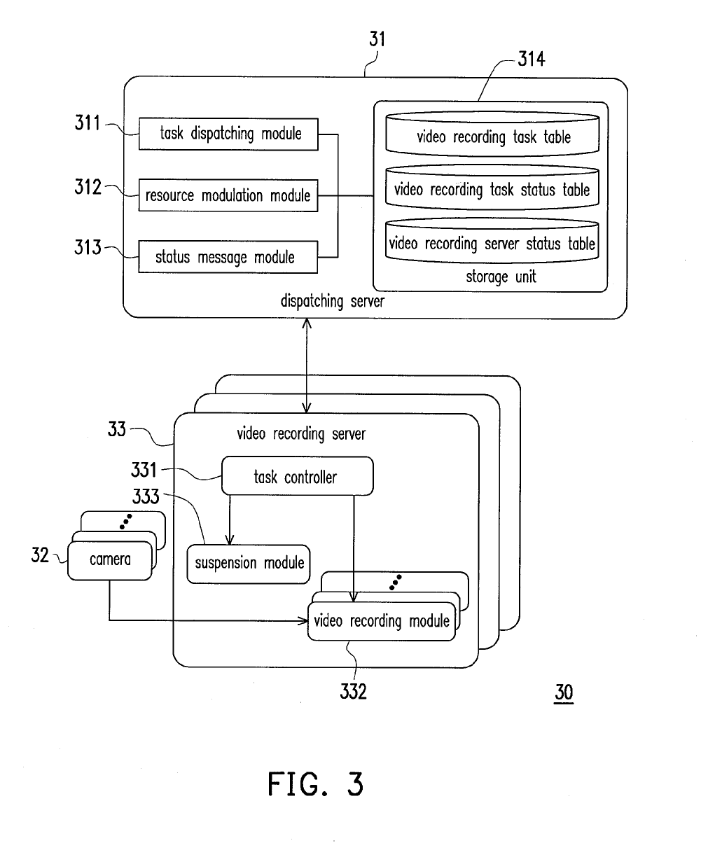

FIG. 3 is a block diagram showing a system of dispatching video recording according to one embodiment of the disclosure. As shown in FIG. 3, in the disclosure, the dispatching system 30 for dispatching video recording comprises a dispatching server 31 and several video recording servers 33. The dispatching system 30 can dispatch the connections to one or more cameras 32 at the local ends or the remote ends to execute the video recording services. The dispatching server 31 comprises a task dispatching module 311, a resource modulation module 312, the status message module 313 and a storage unit 314. Each video recording server 33 comprises a task controller 331, at least one video recording module 332 and a suspension module 333. The input and output of the signals transferring between aforementioned elements and the interaction relationship between aforementioned elements are described in the following paragraphs.

The user utilizes the external request registration program to input the request of the video recording service and the external request registration program records the correlated information of the input request of the video recording service in the video recording service request data table which is provided to the dispatching server 31. The main fields of this video recording service request data table include request Id, start time, end time, camera URI and the user name.

The dispatching server 31, according to the collection logic mentioned above, stores the collected video recording tasks into the video recording task table in the storage unit 314 and the main fields of the video recording task table include task Id, start time, end time and camera URI.

The dispatching server 31 checks the video recording task table and the video recording task status table. When it is found out that the video recording task should be stopped, the video recording server 33 of the corresponding video recording task is informed, according to the field of the server Id in the video recording task status table, to stop executing the video recording task which should be stopped. When it is found out that the video recording task should be executed but actually it is not, the task dispatching module 311 of the dispatching server 31 finds out a video recording server 33 according to a task dispatching strategy to execute the video recording task. The main fields of the aforementioned video recording task status table include task Id, server Id, status time and task status.

When the dispatching server 31 performs the task dispatching strategy and the resource modulation strategy, it further refers to a video recording server status table. The main fields of the video recording server status table include server Id, status time, server status, task capability, total CPU utilization per recording server and available CPU utilization. The aforementioned video recording task table, the aforementioned video recording task status table and the aforementioned video recording server status table are all stored, for example, in the storage unit 314 so as to be accessed anytime by the task dispatching module 311, the resource modulation module 312 and the status message module 313 of the dispatching server 31. In the present embodiment, the storage unit 314 can be, for example, the storage medium, such as the hard disk or the memory, equipped in the dispatching server 31. In another embodiment, the storage unit 314 can be the separated storage device which is separated from the dispatching server 31 and provides data necessary for dispatching tasks to the dispatching server 31 through the network. The video recording task table, the video recording task status table and the video recording server status table stored in the storage unit 314 can be stored separately or together in the storage device inside or outside the dispatching server 31. However, the disclosure is not limited thereto.

The task controller 331 of the video recording server 33 reports two status messages to the status message module 313 of the dispatching server 31. One status message is the status updated information mainly including the data of the video recording task status and the video recording server status and further including the available CPU utilization. Another status message is an operating status message which is periodically reported and mainly includes the information showing whether the video recording server 33 is normally operated.

When receiving the start/stop notice from the dispatching server 31, the video recording server 33 utilizes the task controller 331 to drive the corresponding video recording module or the suspension module 333. The video recording module 332 is used to start or stop the video recording task. The suspension module 333 is used to make the video recording server 333 enter the suspension status.

Each of the video recording servers 33 has at least one video recording module 332 which can be connected to one or more cameras 32 and uses different functional libraries, such as library libvlc or library ffmpeg, for receiving and playing standard images. While operating, the dispatching server 31 can provide the parameters, such as camera connection origins and storing locations of the image contents, to the video recording module 332 through the task controller 331 so as to perform the video recording. After the task controller 331 starts the video recording module 332, the video recording module 332 is connected to the camera 32 and writes the video-audio stream of the video recording service request of the camera 32 into the video-audio medium clip and the video-audio clip description. The video-audio medium clip is the video-audio file which is stored in a form of file. In addition, the video-audio clip description is used to record the information such as the source of the video clip, start/end time of the video clip and the file name.

By using the aforementioned structure, even under the situation of massive and complex video recording service requests, the user only need to submit the video recording service request and the correspondence is handled by the dispatching server 31. The dispatching server 31 automatically assigns the video recording task to the proper video recording server 33 or awakes the suspended video recording server 33 to perform the video recording so that the management can be simplified and the service scale can be flexibly extended.

The dispatching server 31 does not stop managing the video recording service requests of the cameras 32 and the video recording server 33 under condition of the malfunction of the video recording server 33. The recovery mechanism from malfunction is described in the following paragraph.

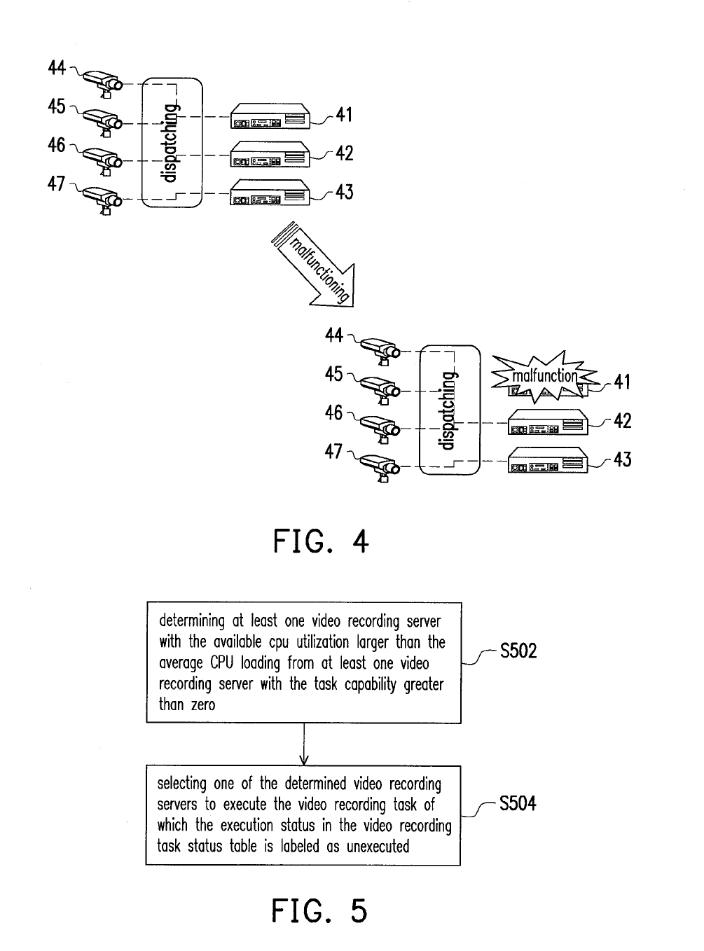

For instance, FIG. 4 is a schematic diagram showing a recovery mechanism from malfunction according to one embodiment of the disclosure. As shown in FIG. 4, in the present embodiment, the dispatching system for dispatching video recording comprises video recording servers 41˜43, wherein the video recording servers 41˜43 are connected to the cameras 44˜47 through the dispatching to perform the video recording. When the video recording server 41 malfunctions which leads to failure in reporting the status of the video recording server 41 for a long time, the dispatching server determines the video recording server 41 is malfunctioned and stops the video recording task executed on the malfunction video recording server 41. Further, the status of the stopped video recording task recoded in the video recording task status table is set to be “unexecuted”. The task dispatching module of the dispatching server reassigns this “unexecuted” video recording task to another video recording server 42 which continuously executes the assigned video recording task.

Task Dispatching Strategy of the Video Recording Task

The present disclosure integrates several parameters, such as computing capability of the video recording server, network flow capability, hardware acceleration capability and cost consideration, into a task capability of the video recording server and provides the task capability of the video recording server to the dispatching server as a reference for dispatching video recording tasks so as to achieve the goal of the video recording management and the resource modulation. An exemplary embodiment in the following is used to describe the disclosure mentioned above.

FIG. 5 is a flow chart showing a method of dispatching video recording according to one embodiment of the disclosure. However, the present disclosure is not limited thereto. As shown in FIG. 3 and FIG. 5, the present embodiment describes the task dispatching strategy of the video recording task of the dispatching server 31 and the following describes the detail steps of the method of dispatching video recording accompanied with each of the elements of the dispatching system 30 shown in FIG. 3.

The task dispatching module 311 of the dispatching server 31 determines one or more video recording servers of which the available CPU utilization is larger than an average CPU loading from one or more video recording servers of which the task capability is greater than zero (step S502). The task dispatching module 311, for example, obtains the newly collected video recording task table and then compares the newly collected video recording task table with the video recording task status table already stored in the storage unit 314 so as to obtain a video recording task with the execution status labelled as unexecuted. Moreover, the task dispatching module 311 further checks a video recording server status table stored in the storage unit 314 to check the statuses of all video recording server 33 so as to determine one or more video recording servers 33 with the task capability greater than zero. The aforementioned task capability f(Task Capability) can be, for example, the product of the available CPU utilization f(Available CPU Utilization) of the video recording server 33, the network capability f(Available Network Utilization), the hardware acceleration capability f(Acceleration Capability) and the cost consideration f(Cost Considering) and the calculation formula is shown below:

f(Task Capability)=f(Available CPU Utilization)×f(Available Network Utilization)×f(Acceleration Capability)×f(Cost Considering) (1)

Wherein, the available CPU utilization f(Available CPU Utilization) is the computing capability of the video recording server 33 for executing the video recording task and is obtained by deducting the product of the average CPU loading for the video recording server 33 handling a single video recording task (average CPU loading per video recording task) and the current task count of the video recording tasks handled by the video recording server 33 (current task count per video recording server) from the total CPU utilization of the processor of the video recording server 33 for executing the computation (total CPU utilization per video recording server), and the calculation formula is shown below:

f(Available CPU Utilization)=total_CPU_utilization_per_video_recording_server−(average_CPU_loading_per_video_recording_task×current_task_count_per_video_recording_server) (2)

Wherein, the total_CPU_utilization_per_video_recording_server is the total CPU utilization of the video recording server which is the computing performance obtained from executing one or more computer programs of the video recording server by using some standard testing procedures. Moreover, in another embodiment, the total CPU utilization per video recording server is the average execution rate for executing the integer operation command. The average_CPU_loading_per_video_recording_task is the average CPU loading of the video recording server which is the average CPU utilization for handling a single video recording task.

Similarly, the available network utilization f(Available Network Utilization) is obtained by subtracting the product of the average network loading for the video recording server 33 transmitting a single video recording task (average network loading per video recording task) and the current task count of the video recording tasks transmitted by the video recording server 33 (current task count per video recording server) from the total network utilization for the video recording server 33 to transmit data (total network utilization per video recording server), in which the available network utilization is determined by the product f(Temp Available Network Utilization), and the calculation formula is shown below:

f(Temp Available Network Utilization)=total_network_utilization_per_video_recording_server−(average_network_loading_per_video_recording_task×current_task_count_per_video_recording_server) (3)

Wherein, when the product f(Temp Available Network Utilization) is smaller than a network threshold value, the available network utilization f(Available Network Utilization) is set to be zero. Otherwise, the available network utilization f(Available Network Utilization) is set to be one.

Further, the total network utilization of the video recording server (total_network_utilization_per_video_recording_server) is the maximum network flow of the network interface card on the individual video recording server. The network threshold value can be set by one of the following methods: multiplying the uploading flow of the network interface card with a specific ratio, multiplying the downloading flow of the network interface card with a specific ratio or multiplying the total of the uploading flow and the downloading flow with a specific ratio.

The hardware acceleration capability f(Acceleration Capability) is obtained from considering the weight value of the video recording server 33 of which the hardware does not possess acceleration capability, the weight values of various hardware acceleration capabilities and the parameter of the hardware acceleration capability. The calculation formula of the hardware acceleration capability is shown below:

$$f ( Acceleration Capability ) = \frac{{W}_{0} + {\sum }_{j = 1}^{n} {W}_{j} {R}_{ij}}{{\sum }_{j = 0}^{n} {W}_{j}} \qquad ( 4 )$$

W₀ represents the weight value of the display card of the video recording server which does not possess any acceleration capability for handling coding-decoding operation. Wⱼ represents the weight values which are set in accordance with different hardware acceleration capabilities. For instance, the user can use a coding-decoding list (CODEC List) listing the specific codes of codec, such as the hardware acceleration capability items including MJPEG, MPEG2, MPEG4, H.263 and H.264, which can be handled by the display card of the video recording server. This list can be flexibly set according to the user requirements or the expansion of the acceleration capability of the hardware. Further, j is the corresponding location index of the list. In the present embodiment, j referring to MJPEG is 1 and j referring to H.264 is 5. Wⱼ are the weight values for MJPEG, MPEG2, MPEG4, H.263 and H.264 respectively set by the user. Theses weight values, including W₀, are set by the user and are greater than or equal to zero, generally. Rᵢⱼ represents the parameter of the hardware acceleration capability which is determined by whether the display card of the video recording server possess the hardware acceleration capability of the code of codec in the list with the location index j. If yes, Rᵢⱼ equal to one, and otherwise Rᵢⱼ equal to zero. The numerator of the formula 4 is the sum of the weight value of the non-hardware acceleration capability of the video recording server 33 and the sum of the products of the parameters of the hardware acceleration capability Rᵢⱼ and the corresponding weight values Wⱼ. The denominator of the formula 4 is the sum of the weight values of various hardware acceleration capabilities and the non-hardware acceleration capabilities. A normalized hardware acceleration capability can be obtained by the numerator divided by the denominator.

The cost consideration f(Cost Considering) is determined by, for example, the product of numerous cost parameters and the calculation formula is shown below:

f(Cost Considering)=(Π₁ⁿCⱼ)^{C0} (5)

Wherein, C0 represents the evaluation with or without taking the operation cost of the video recording server 33 into account. If the evaluation does not take any operation cost into account, C0 is equal to zero, and otherwise C0 is equal to one. Further, i equal to 1 represents the situation that the processor stability of the video recording server 33 is taken into account. If the processor stability of the video recording server 33 is taken into account and the measured temperature of the processor is larger than the threshold value of the processor temperature, C1 is equal to 0 and otherwise C1 is equal to one. Moreover, i equal to 2 represents the situation that the stability of the hard disk of the video recording server 33 is taken into account. If the stability of the hard disk of the video recording server 33 is taken into account and the measured temperature of the hard disk is larger than the threshold value of the hard disk temperature, C2 is equal to 0 and otherwise C2 is equal to one. The aforementioned kinds of the cost consideration f(Cost Considering) are only for the exemplary descriptions and the present disclosure is not limited thereto. The skilled artisan in the field can adopt adequate cost parameters according to the practical requirement to be the basis for determining the cost consideration.

In another embodiment, the aforementioned task capability f(Task Capability) can be obtained by, for example, subtracting the product of the average recording frame per second (FPS) of the video recording server 33 handling a single video recording task (average video recording FPS per video recording task) and the current task count of the video recording tasks handled by the video recording server 33 (current task count per video recording server) from the total video recording FPS of the video recording server 33 (total video recording FPS per video recording server) and the calculation formula is shown below:

f(Task Capability)=total_video_recording_FPS_per_video_recording_server−(average_video_recording_FPS_per_video_recording_task×current_task_count_per_video_recording_server) (6)

Wherein, the total_video_recording_FPS_per_video_recording_server is the total video recording FPS of the video recording server 33 which is the maximum frame size obtained by measuring the FPS of each of the video recording servers.

After the video recording servers having the task capability greater than zero are determined, the task dispatching module 311 determines one or more video recording servers 33 having the available CPU utilization larger than the average CPU loading among the previously determined video recording servers.

Thereafter, the task dispatching module 311 assigns the video recording task to one of the selected video recording servers and the video recording server can be selected, for example, by random pick, sequentially pick or by picking the last booting video recording server. Alternatively, one of the video recording servers with the maximum total CPU utilization per video recording server can be selected, for example. Meanwhile, the execution status of the video recording task in the video recording task status table is changed to be a currently executed status (step S504) so that the video recording tasks are aggregated on the video recording server 33 with the higher resource utilization.

Meantime, the task controller 331 of the assigned video recording server 33 deducts the average CPU loading from the available CPU utilization of the assigned video recording server and then reports the changes of the video recording task status and the video recording server status to the status message module 313 of the dispatching server 31. When the task dispatching module 311 dispatches the video recording tasks and no available video recording server 33 can be found according to the aforementioned conditions, the suspended video recording server 33 is awoke so as to perform the assignation of the video recording tasks. If there is no suspended video recording server 33, the execution status of the video recording task remains as an unexecuted status.

After finishing the dispatch of one video recording task, the task dispatching module 311 continues to obtain other video recording tasks whose execution statuses in the video recording task status table are marked as unexecuted and to assign those video recording tasks to other video recording server 33 until the execution statuses of all of the video recording tasks are marked as executed statuses.

Handling the Unusual Situation of the Video Recording Server

When the video recording server malfunctions, the task controller of the malfunction video recording server cannot report the status message. Accordingly, in the present disclosure, the dispatching system for dispatching video recording tasks, in the step of checking the video recording server and the video recording task status, further re-assigns the video recording task to recover the video recording service from failure according to the statuses of the video recording servers.

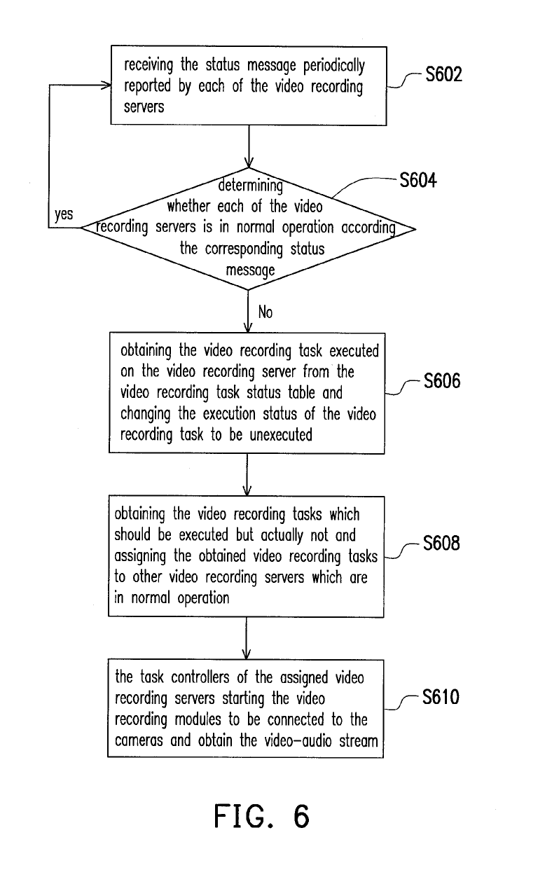

FIG. 6 is a flow chart showing a method for handling the malfunction video recording server according to one embodiment of the disclosure and the present disclosure is not limited thereto. As shown in FIG. 3 together with FIG. 6, the present embodiment describes handling procedure while the video recording server 33 in FIG. 3 malfunctions and the malfunction handling procedure is described accompanied with every element of the dispatching system 30 shown in FIG. 3 in the following.

The dispatching server 31 continues to receive the status message periodically reported by each of the video recording server 33 (step S602) and determines whether each of the video recording servers 33 is in normal operation according to the corresponding status message (step S604). When the dispatching server 31 discovers the time during which the video recording server 33 does not report the status message is larger than the threshold value of abnormal un-report from the status data, the video recording server 33 is determined to be in abnormal operation. Hence, the video recording task executed on the video recording server 33 is obtained from the video recording task status table and the execution status thereof is changed to be unexecuted (step S606) so as to re-assign the video recording task to the other video recording servers 33. The dispatching server 31, for example, changes the task capability of the video recording server 33 in the video recording server status table to be zero and excludes the video recording server 33 from the available list of video recording servers.

The dispatching server 31 obtains the video recording tasks which should be executed but actually not and assigns the obtained video recording tasks to other video recording servers 33 which are in normal operation (step S608) and the task controllers of the video recording servers 33 start the video recording modules 332 and connect to the necessary cameras 32 to obtain the video-audio stream (step S610). The task controller of the video recording server which is assigned with the video recording task further deducts the average CPU loading from the available CPU utilization, and then reports the changes of the video recording task status and the video recording server status to the status message module 313 of the dispatching server 31.

Handling the Abnormal Connection of the Cameras

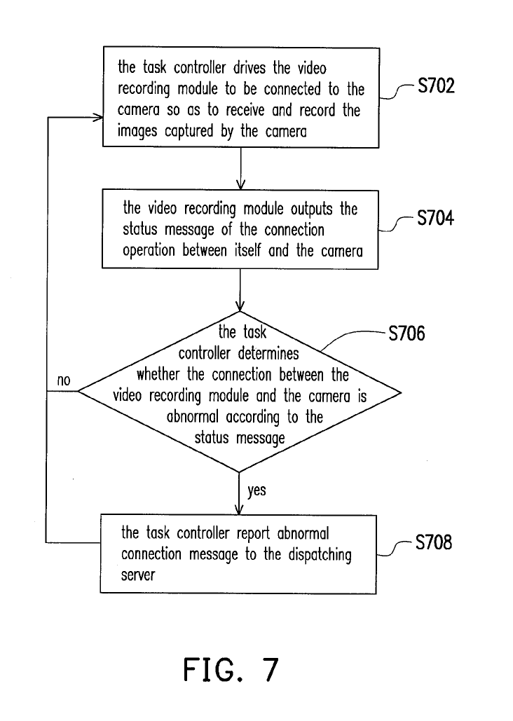

FIG. 7 is a flow chart showing a method for handling the unusual connection of the cameras according to one embodiment of the disclosure and the disclosure is not limited thereto. As shown in FIG. 7 together with FIG. 3, the present embodiment describes handling procedure while the camera 32 in FIG. 3 malfunctions and the malfunction handling procedure is described accompanied with every element of the dispatching system 30 shown in FIG. 3 in the following.

When the video recording tasks are assigned to the video recording server 33, the task controller 331 of the video recording server 33 drives the video recording module 332 to connect to the camera 32 so as to receive and record the images captured by the camera 32 (step S702).

In the operation procedure, the video recording module 332 outputs the status message of the connection operation between the video recording module 332 and the camera 32 (step S704) and the task controller 331 determines whether the connection between the video recording module 332 and the camera 32 is abnormal according to the status message (step S706).

When the camera 32 malfunctions, which leads to connection failure or failure to obtain image data, the video recording module 332 determines that the connection is fail and sends the status message “error” to the task controller 331. After receiving the status message “error”, the task controller 331 reports abnormal connection message to the dispatching server 31 (step S708). Meanwhile, the task controller 331 returns to the step S702 to re-start the video recording service and if the error still happens, the task controller 331 repeats the same action until the connection is successfully established or the dispatching server 31 issues a stop command on the video recording task to terminate the video recording task.

Resource Modulation Strategy of the Video Recording Server

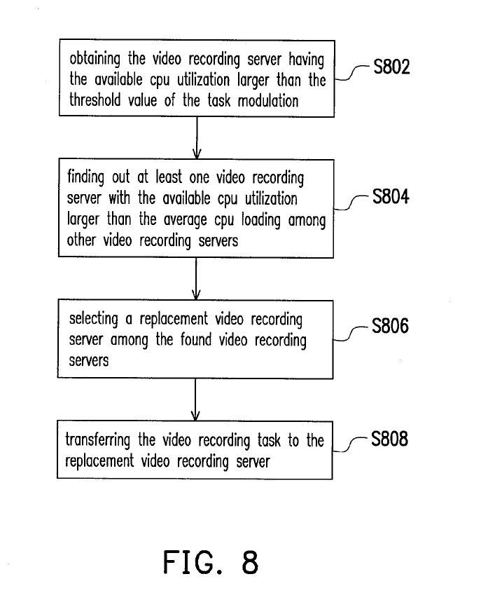

FIG. 8 is a flow chart showing a method for modulating resources of the video recording servers according to one embodiment of the disclosure and the disclosure is not limited thereto. As shown in FIG. 3 together with FIG. 8, in the present embodiment, the dispatching server 31 in FIG. 3 automatically adjusts the video recording server 33 with high available CPU utilization to be in an idle status and then to enter the suspension status so that the hardware resource consumption can be decreased. The resource modulation procedure is described accompanied with every element of the dispatching system 30 in FIG. 3 in the following.

At the beginning of the modulation of the video recording task, the resource modulation module 312 of the dispatching server 31 obtains the video recording server 33 having the available CPU utilization larger than the threshold value of the task modulation (step S802), and then finds out one or more video recording servers 33 with the available CPU utilization larger than the average CPU loading among other video recording servers 33 (step S804).

The resource modulation module 312 selects a replacement video recording server 33 among the found video recording servers 33 in step S804 (step S806). The method for selecting the replacement video recording server 33 can be, for example, random pick, sequentially pick or picking the last booting video recording server. Alternatively, one of the video recording servers with the maximum total CPU utilization per video recording server and larger than the current video recording server 33 can be selected, for example. If the resource modulation module 312 finds out the replacement video recording server capable of executing the video recording task, the video recording task is transferred to the replacement video recording server (step S808). If the resource modulation module 312 cannot find any replacement video recording server, it stops the task modulation. When the resource modulation module 312 transfers the video recording task to the replacement video recording server 33, the task controller 331 of the replacement video recording server 33 starts the video recording module 332 and monitors the output message from the video recording module 332. After the video recording module 332 is connected to the camera 32 and obtains the video-audio stream of the request video recording service, the video recording module 332 outputs the operation messages to the task controller 331 in which the operation messages comprises start message, stop message and error message. The task controller 331 deducts the average CPU loading from the available CPU utilization of the replacement video recording server 33 and further reports the changes of the video recording task status and the video recording server status to the status message module 313 of the dispatching server 31. Further, the dispatching server 31 updates the execution status of the video recording task to be transferred.

Meanwhile, the resource modulation module 312 further finds out the video recording server 33 which originally executes the video recording task and commands the found video recording server 33 to stop video recording. The task controller 331 of the found video recording server 33 sends the stop video recording message. For instance, the escape character (ESC) in the American Standard Code for Information Interchange (ASCII) is sent to the video recording module 332 to stop the video recording module 332 executing the video recording task. After the video recording module 332 is disconnected from the camera 32, the task controller 331 adds the available CPU utilization of the video recording server 33 and the average CPU loading together and then reports the changes of the video recording task status and the video recording server status to the status message module 313 of the dispatching server 31. Further, the dispatching server 31 updates the status of the video recording server 33.

The Suspension and Awaking of the Video Recording Server

After the video recording task is transferred, the video recording server originally executing the video recording task enters the idle status and the dispatching server further determines whether the idle time of the idle video recording server is larger than a threshold value of idle time. When determining the idle time of the idle video recording server larger than the threshold value of the idle time, the dispatching server forces the video recording server to enter the suspended status. After receiving the suspension task command, the task controller of the video recording server starts the suspension module to execute the suspension function provided by the operating system so as to suspend the video recording server.

Moreover, as for the video recording server in the suspension status, when the dispatching server dispatches the video recording tasks and cannot find the available video recording server which is currently running (for instance, no video recording server with task capability greater than zero is found), the dispatching server makes a preferential selection on one of the suspended video recording servers and sends an awake message (such as the message of wake-up on LAN, WOL) to the selected suspended video recording server to awake the selected suspended video recording server. After awaking the selected suspended video recording server, the dispatching server assigns the video recording task to the awoke video recording server. The method for selecting one of the suspended video recording servers can be, for example, random pick, sequentially pick or picking the last booting video recording server. Alternatively, one of the suspended video recording servers with the maximum total CPU utilization can be selected, for example.

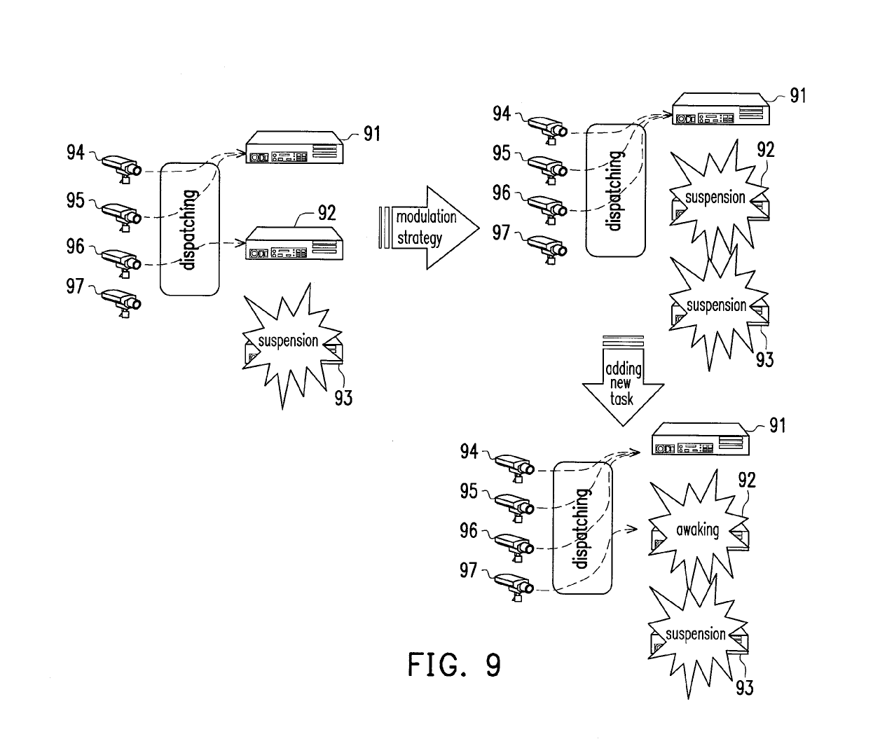

FIG. 9 is a schematic diagram showing a suspending procedure and a resuming procedure of the video recording server according to one embodiment of the disclosure and the disclosure is not limited thereto. As shown in FIG. 9, in the present embodiment, the dispatching system comprises video recording servers 91˜93. The dispatching system 30 may dynamically dispatch connections to the cameras 94˜97 at the local ends or the remote ends to execute the video recording services. In the beginning status, the video recording servers 91 and 92 execute the video recording tasks of the cameras 94˜96. When starting to implement the modulation strategy, the dispatching server obtains the resource utilization statuses of the video recording servers 91˜93 from the video recording server status table, for example. If the busier video recording server 91 still can carry on extra video recording tasks, the dispatching server transfers the video recording tasks originally assigned to the idler video recording server 92 to the video recording server 91 so that the utilization of the video recording server 91 is increased and the idler video recording server 92 without being assigned any video recording task enters the suspension status with less power consumption.

Moreover, when receiving a new video recording task (such as the video recording task of the camera 97), the dispatching server obtains the resource utilization statuses of the video recording servers 91˜93, for example. If the video recording server 91 in running cannot execute the video recording task, the dispatching server awakes another video recording server 92 and assigns the new video recording task to the awoke video recording server 92.

Altogether, in the present disclosure, the method and system of dispatching video recording integrate several parameters, such as operation capability of the video recording server, network flow capability, hardware acceleration capability and cost consideration, into a task capability of the video recording server and provide the task capability of the video recording server to the dispatching server as a reference for such as dynamically dispatching video recording tasks, which can further combines the management of the video recording services and the resource modulation of one or more cameras to achieve the functions of effectively utilizing resources and rapidly recovering malfunction video recording service. Also, by transferring the video recording tasks to the video recording server with high available CPU utilization, the utilization of the hardware resource and the power can be greatly improved to achieve a better utilization efficiency of the system resource.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method of dispatching video recording, comprising:
determining one or more video recording servers with an available CPU utilization larger than an average CPU loading from one or more video recording servers having a task capability greater than zero; and
selecting one of the determined one or more video recording servers to execute a video recording task with an execution status labelled as an unexecuted status in a video recording task status table.

2. The method of claim 1, further comprising:
periodically re-obtaining another video recording task with the execution status labelled as the unexecuted status from the video recording task status table and assigning the another video recording task to a selected video recording server.

3. The method of claim 1, further comprising:
receiving a video recording service request;
adding at least one video recording task corresponding to the video recording service request to the video recording task status table; and
labeling the execution status of the at least one video recording task to be the unexecuted status.

4. The method of claim 1, further comprising:
receiving a status message periodically reported from each of the one or more video recording servers;
determining whether the one or more video recording servers are normally operated according to the corresponding status message; and
when the one or more video recording servers are determined to be not normally operated, changing the execution status of the video recording task executed by the one or more video recording servers to the unexecuted status.

5. The method of claim 4, when the one or more video recording servers are determined to be not normally operated, further comprising:
changing the task capability of the one or more video recording servers to zero.

6. The method of claim 1, further comprising:
driving the selected video recording server to connect to at least one camera corresponding to the video recording task so that the selected video recording server receives and records at least one image captured by the at least one camera.

7. The method of claim 6, further comprising:
the video recording server determining whether a connection between the video recording server and at least one camera is abnormal; and
if the connection is determined to be abnormal, the one or more video recording servers reporting an abnormal connection message to a dispatching server and repeatedly executing an connection action until the connection is successfully established or until the dispatching server stops the video recording task.

8. The method of claim 1, further comprising:
obtaining a modulation required video recording server with the available CPU utilization larger than a task modulation threshold value;
finding one or more video recording servers with the available CPU utilization larger than the average CPU loading among other video recording servers;
finding a replacement video recording server with a total CPU utilization larger than the modulation required video recording server from therein the found one or more video recording servers; and
transferring the video recording task to the replacement video recording server.

9. The method of claim 1, further comprising:
determining whether an idle time of each of the one or more video recording servers is larger than an idle time threshold value; and
when the idle time is larger than the idle time threshold value, forcing the one or more video recording servers to enter an suspension status.

10. The method of claim 1, further comprising:
if there is no video recording server with the task capability greater than zero, awaking a suspended video recording server; and
assigning the video recording task to the awoke suspended video recording server.

11. The method of claim 1, wherein the task capability is the product of the available CPU utilization, a network capability, a hardware acceleration capability and a cost consideration of each of the one or more video recording servers.

12. The method of claim 1, wherein the task capability is obtained by subtracting a product of an average recording frame per second of the video recording server handling a single video recording task and a current task count handled by the video recording server from a total video recording frame per second which can be video recorded by the video recording server.

13. The method of claim 1, wherein the task capability of the one or more video recording servers is marked in a video recording server status table.

14. The method of claim 1, wherein the available CPU utilization is obtained by deducting a product of the average CPU loading for handling a single video recording task and a current task count handled by the video recording server from a total CPU utilization of a processor of the video recording servers.

15. The method of claim 1, wherein a video recording server with a maximum total CPU utilization is selected from the one or more video recording servers to execute the video recording task.

16. The method of claim 8, wherein the total CPU utilization of the replacement video recording server is the maximum.

17. The method of claim 10, wherein a total CPU utilization of the awoke video recording server is the maximum.

18. The method of claim 1, further comprising:
changing the execution status of the video recording task in the video recording task status table to be a currently executed status.

19. A system for dispatching video recording, comprising:
a dispatching server, including:
a task dispatching module, determining one or more video recording servers with an available CPU utilization larger than an average CPU loading from therein one or more video recording servers having a task capability greater than zero, selecting one of the determined one or more video recording servers and assigning a video recording task to the selected video recording server with an execution status labelled as an unexecuted status in a video recording task status table.

20. The system of claim 19, wherein the task dispatching module further periodically re-obtains another video recording task with the execution status labelled as the unexecuted status from the video recording task status table and assigns the another video recording task to a selected video recording server.

21. The system of claim 19, wherein the task dispatching module further receives a video recording service request, adds at least one video recording task corresponding to the video recording service request to the video recording task status table and labels the execution status of the at least one video recording task to be the unexecuted status.

22. The system of claim 19, wherein the dispatching server further comprises:
a status message module, receiving a status message periodically reported from each of the one or more video recording servers, determining whether the one or more video recording servers are normally operated according to the corresponding status message and changing the execution status of the video recording task executed by the one or more video recording servers to be the unexecuted status when the one or more video recording servers are determined to be not normally operated, so as to re-assign the video recording task to other video recording server by the task dispatching module.

23. The system of claim 22, wherein when the status message module determines one or more video recording servers are not normally operated, the status message module further changes the task capability of the one or more video recording servers to be zero in a video recording server status table.

24. The system of claim 22, wherein each of the one or more video recording servers comprises:
a video recording module; and
a task controller, starting the video recording module to be connected to at least one camera corresponding to the video recording task and receiving and recording at least one image captured by the at least one camera.

25. The system of claim 24, wherein the task controller further determines whether a connection to the at least one camera is abnormal, and reports an abnormal connection message to the status message module if the connection is determined to be abnormal, so as to start the video recording module to repeatedly executes an connection action until the connection is successfully established or until the dispatching server issues a stop command to stop the video recording task.

26. The system of claim 19, wherein the dispatching server further comprising:
a resource modulation module, determining whether the available CPU utilization of each of the one or more video recording servers is larger than a task modulation threshold value, and when the available CPU utilization of each of the one or more video recording servers is determined to be larger than the task modulation threshold value, then finding at least one video recording server with the available CPU utilization larger than the average CPU loading among other video recording servers of the one or more video recording servers, and finding a replacement video recording server with a total CPU utilization larger than the modulation required video recording server from therein the found at least one video recording server so as to transfer the video recording task to the replacement video recording server.

27. The system of claim 19, wherein the task dispatching module further determines whether an idle time of each of the one or more video recording servers is larger than an idle time threshold value and, when the idle time is larger than the idle time threshold value, forces the one or more video recording servers to enter a suspension status.

28. The system of claim 19, wherein the task dispatching module further awakes a suspended video recording server when there is no video recording server with the task capability greater than zero and assigns the video recording task to the awoke suspended video recording server.

29. The system of claim 19, wherein the task capability is the product of the available CPU utilization, a network capability, a hardware acceleration capability and a cost consideration of each of the video recording servers.

30. The system of claim 19, wherein the task capability is obtained by subtracting a product of an average recording frame per second of the video recording server handling a single video recording task and a current task count handled by the video recording server from a total video recording frame per second which can be video recorded by the video recording server.

31. The system of claim 19, wherein the available CPU utilization is obtained by deducting a product of the average CPU loading for handling a single video recording task and the current task count handled by the video recording server from a total CPU utilization of a processor of the video recording servers.

32. The system of claim 19, wherein the task dispatching module selects a video recording server with a maximum total CPU utilization from the one or more video recording servers to execute the video recording task.

33. The system of claim 26, wherein the total CPU utilization of the replacement video recording server is the maximum.

34. The system of claim 28, wherein the task dispatching module awakes a video recording server with the maximum total CPU utilization.

35. The system of claim 19, further comprising:
changing the execution status of the video recording task in the video recording task status table to be a currently executed status.

36. The system of claim 19, further comprising:
a storage unit, storing the video recording task status table and a video recording server status table for recording the task capability.
